(19) United States
(12) Patent Application Publication
(10) Pub. No.: US 2004/0016327 A1
(43) Pub. Date: Jan. 29, 2004

(54) Rack for retaining tool holders

(76) Inventor: Ricky D. Huntington, Palmdale, CA (US)

Correspondence Address: ARTHUR FREILICH, 9045 CORBIN AVE, #260, NORTHRIDGE, CA, 91324-3343, US

(21) Appl. No.: 10/206,294

(22) Filed: Jul. 26, 2002

(51) Int. Cl. B23B 25/00

(52) U.S. Cl. 82/160

(57) ABSTRACT

A rack including at least one substantially horizontally oriented hanger member. The hanger member defines a cross-sectional profile dimensioned and shaped to fit within the mounting keyway of a standard tool holder thus enabling the tool holder to be suspended, or hung form the hanger member. The rack includes a retention means for inhibiting translational movement of the tool holder along the hanger member.

### FIELD OF THE INVENTION

This invention relates to a rack for retaining quick change tool holders in an organized manner to enable them to be readily stored and retrieved by a machine operator.

### BACKGROUND OF THE INVENTION

It is well known for operators of metal cutting machines to use quick change tool holders to enable machining operations to be performed more quickly and efficiently. Such tool holders are configured to be removably mounted on a quick change tool post which in turn is installed on a metal cutting machine, such as a lathe or mill.

Quick change tool systems (i.e., mating tool holders and tool posts) are well known in the art and are widely sold under various brand names including KDK, Aloris, Dorian, and Prestige. A quick change tool post is generally configured with a projecting male key having a cross-sectional profile typically comprising an isosceles trapezoid. A mating tool holder is configured with a female keyway having a correspondingly shaped cross-sectional profile for accommodating the tool post key.

A typical machining operation requires the use of multiple cutting tools. Quick change tool systems are commonly used because they enable an operator to rapidly and efficiently change tools in the course of a machining operation while also enhancing machining repeatability and reducing set-up time.

More particularly, in a typical operation, an operator is likely to use several different quick change tool holders, each carrying a different cutting tool, to machine a single part. For example, it is not unusual in a typical lathe operation to use an external turning tool, an internal turning tool, a cut-off tool, a threading tool and a boring bar to execute the desired machining steps. The execution of these steps typically necessitate that the operator repeatedly mount and remove tool holders from one or more installed tool posts. Thus, in the course of an operation, an operator may have multiple inactive tool holders laying around awaiting subsequent use. Typically an operator will place the inactive tool holders upon any convenient surface, e.g., the head case, cross-feed plate, or lathe bed. This situation is inherently unsafe inasmuch as it often requires that the operator place his hand in close proximity to moving machine parts in order to retrieve a tool holder. Moreover, tool holders and tools are subject to damage when not in use when haphazardly placed on parts of the machine.

U.S. Pat. No. 5,209,147 describes a vertically oriented stand for supporting a tool holder so that the tool is protected from damage when not in use and is readily accessible to a machine operator.

### SUMMARY OF THE INVENTION

The present invention is directed to a rack including at least one substantially horizontally oriented hanger member. The hanger member defines a cross-sectional profile dimensioned and shaped to fit within the mounting keyway (typically having an isosceles trapezoidal profile) of a standard tool holder, thus enabling the tool holder to be suspended, or hung, from the hanger member.

In accordance with preferred embodiments of the invention, the cross-sectional profile of the hanger member includes a portion configured to fit within an included acute angle of a tool holder's keyway to engage the tool holder and suspend, or hang, it substantially vertically from the hanger member.

In accordance with preferred embodiments of the invention, the hanger member extends forwardly from a vertically oriented mounting plate which is adapted to be secured to a wall or any other vertical surface convenient to the operator. The hanger member defines a rear face supported proximate to the mounting plate and a front face spaced forwardly from the mounting plate.

In accordance with preferred embodiments of the invention, retention means are provided for preventing, or inhibiting, translational movement of a tool holder along the hanger member. The retention means prevents the tool holder from vibrating forwardly and falling off the hanger member. Embodiments of the invention are preferably configured to require that a tool holder keyway be first placed around the hanger member so that it can then be rotated into position to suspend the tool holder from the hanger member.

In accordance with a first preferred embodiment, the retention means comprises a retention plate adapted to be fastened to the front face of the hanger member. The retention plate is dimensioned to extend beyond the cross-sectional profile of the hanger member to form a flange for preventing forward translational movement of the tool holder.

In accordance with a second preferred embodiment, the retention means includes a spring urged detent carried by the hanger member for engaging the tool holder to prevent vibration of the tool holder and its forward translational movement.

In accordance with a third preferred embodiment, the retention means comprises a magnet acting on the tool holder to retain it proximate to the hanger member mounting plate.

A preferred rack assembly in accordance with the invention is comprised of multiple rack modules, each module including a single hanger member cantilevered from a mounting plate. The hanger member preferably comprises a discrete part which can be removably fastened to the mounting plate. This enables an operator to select and install hanger members having cross-sectional profiles most appropriate to the tool holders being used.

### BRIEF DESCRIPTION OF THE FIGURES

FIG. 1 is an isometric exploded view of a first rack embodiment in accordance with the invention for storing the illustrated conventional tool holder;

FIG. 2 is a front plan view of a rack assembly comprised of multiple rack modules of the type depicted in FIG. 1 and depicts how a tool holder is suspended from a hanger member;

FIG. 3 is an isometric exploded view similar to FIG. 1 showing a second rack embodiment in accordance with the invention;

FIG. 4 is a front plan view similar to FIG. 2 showing a rack assembly comprised of multiple rack modules of the type depicted in FIG. 3;

FIG. 5 is a sectional view taken substantially along the plane 5-5 of FIG. 4;

FIG. 6 is an isometric exploded view similar to FIG. 5 depicting a third rack embodiment;

FIG. 7 is a front view of a rack assembly comprised of multiple rack modules of the type depicted in FIG. 6;

FIGS. 8, 9, 10 are isometric exploded views similar to FIG. 1 respectively illustrating variation of the rack embodiment illustrated in FIG. 6.

### DETAILED DESCRIPTION

So called “quick change” systems are well known for mounting cutting tools on metal cutting machines, e.g., lathes. Such systems are typically comprised of a tool post and a tool holder which are configured to be mated via a dovetail slide connection. Usually the dovetail slide connection is comprised of a male key on the tool post having a cross-sectional profile forming an isosceles trapezoid and a female keyway on the tool holder having a correspondingly shaped profile dimensioned to snugly receive the post key. Although alternative key and keyway profiles are known, the trapezoidal profile is most commonly used and will, for convenience, be assumed hereinafter.

FIG. 1 illustrates a typical commercially available quick change tool holder 20 which basically comprises a metal block 22 having a mounting keyway 24 formed therein. The keyway 24 is depicted as having a trapezoidal profile defined by a first base line 26 and first and second side lines 28, 30 converging therefrom toward an open second base line. Included acute angles 32, 34 are respectively defined between base line 26 and side lines 28, 30. The tool holder 20 also defines a recess 36 configured to receive and hold a cutting tool 38. Typical keyway dimensions for a standard tool holder are as follows:

| | | |
|---|---|---|
| base line 26 = | 1.725 | inches |
| side lines 28, 30 = | 0.325 | inches |
| included angles = | 60 | degrees |

The present invention is directed to a rack 40 adapted to be mounted on a wall near a cutting machine for enabling a machine operator to readily store and retrieve inactive tool holders. FIG. 1 depicts a first rack embodiment in accordance with the invention and is characterized by a hanger member 46 having a first or rear, face 48 and a second, or front, face 50. The hanger member 46 is configured to be secured to a mounting plate 52 which is intended to be fastened to a wall or other vertical surface, as by screws 53 passing through countersunk holes 54 in mounting plate 52.

The hanger member 46 is preferably apertured at 56 for passing bolts 58 intended to be threaded into mounting plate holes 60. The bolts 58 extend through countersunk holes 62 formed in retention plate 64 to hold the retention plate against the hanger member front face 50 while also securing the hanger member rear face 48 against the front surface 66 of mounting plate 52.

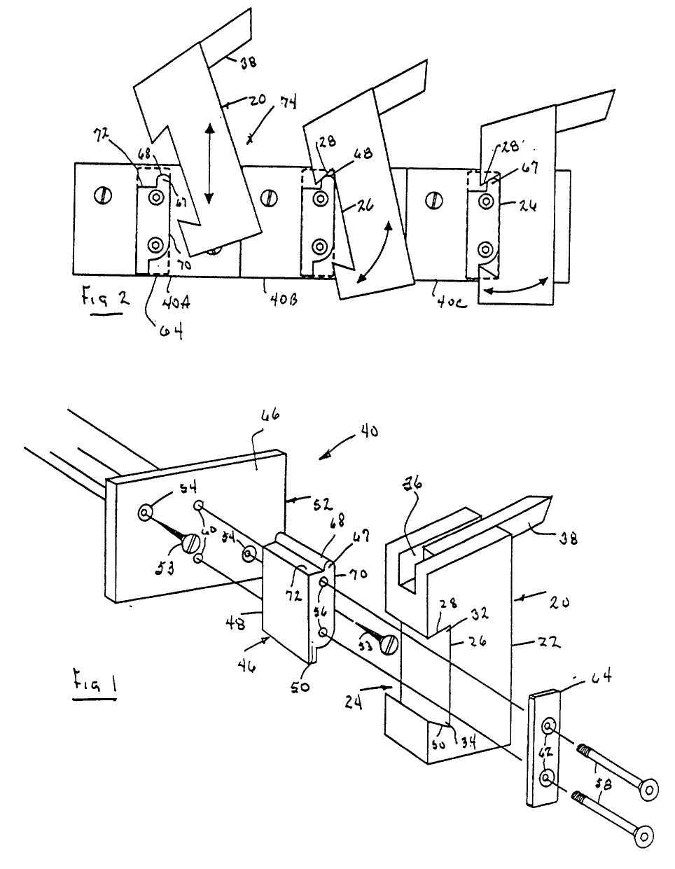

The hanger member 46 defines a cross-sectional profile which is shaped and dimensioned to be accommodated in the mounting keyway 24 of tool holder 20. The hanger member profile preferably includes a projecting portion 67 having a radiused upper surface 68 adapted to nest within the included acute angle 32 between the keyway base line 26 and first side line 28, as shown in FIG. 2. The radiused surface 68, as will be discussed hereinafter, functions to support a tool holder 20 suspended thereon and acts as the fulcrum point around which the tool holder 20 can rotate as it is placed on or removed from the hanger member 46. As shown in FIGS. 1 and 2, the projecting portion 67 constitutes an extension of vertical surface 70 projecting beyond horizontal surface 72.

FIG. 2 depicts a modular rack assembly 74 in accordance with the invention comprised of multiple racks (or rack modules) 40 of the type illustrated in FIG. 1. Although FIG. 2 depicts assembly 74 as including three racks 40A, 40B, 40C, it should be understood that a rack assembly in accordance with the invention can be comprised of any arbitrary number of racks.

FIG. 2 also shows how a tool holder 20 is placed on a hanger member 46 for storage, by illustrating progressive transitional positions of the tool holder 20 from left to right, i.e., with respect to racks 40A, 40B, and 40C respectively. More particularly, note on the left of FIG. 2 that the acute angle 32 of a tool holder 20 is brought into alignment with the projecting portion 67 of hanger member 46A. The center portion of FIG. 2 shows with respect to rack 40B, how the tool holder acute angle is lowered onto the projecting portion 67 to suspend the tool holder therefrom and allow it to rotate (clockwise as viewed in FIG. 2) around radiused surface 68 to a vertically oriented storage position as depicted with respect to rack 40C. The dimensions and shape of the hanger member are selected so that preferably the weight of the tool holder 20 will rotate it to the essentially vertical orientation depicted at the right of FIG. 2.

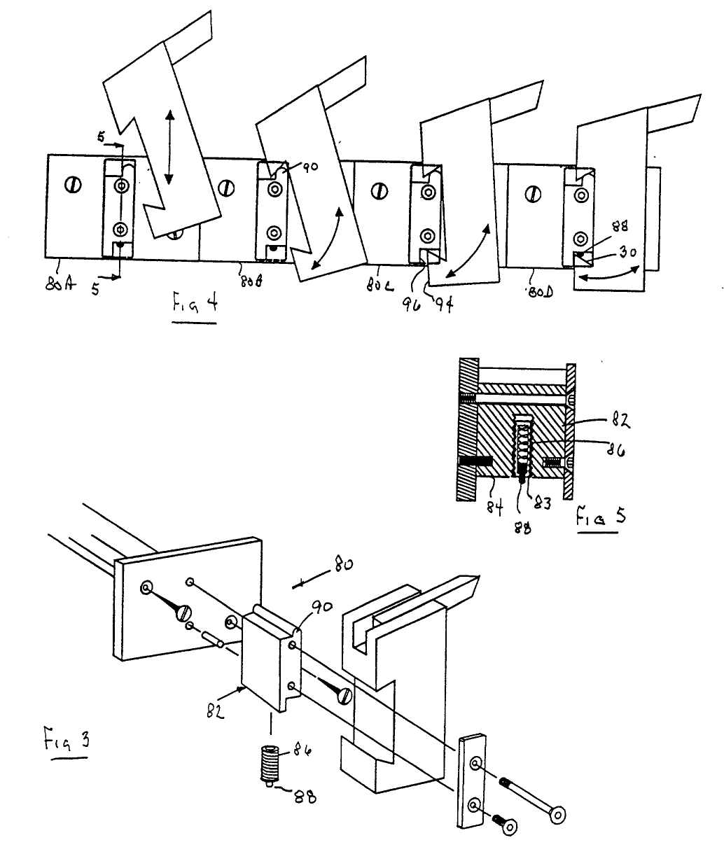

It is pointed out with regard to FIGS. 1 and 2 that the tool holder 40 is placed on the hanger member 46 between the mounting plate 50 and the front retention plate 64. The retention plate 64 (shown in dashed line in FIG. 2) is dimensioned so that its profile extends beyond the cross-sectional profile of the hanger member 46 to effectively form a flange for preventing forward translational movement of the tool holder 20 along the hanger member 46. In the absence of the retention plate 64, or some other retention means (see FIGS. 3-6), vibrations could move the tool holder forwardly along, and then off, the hanger member 46.

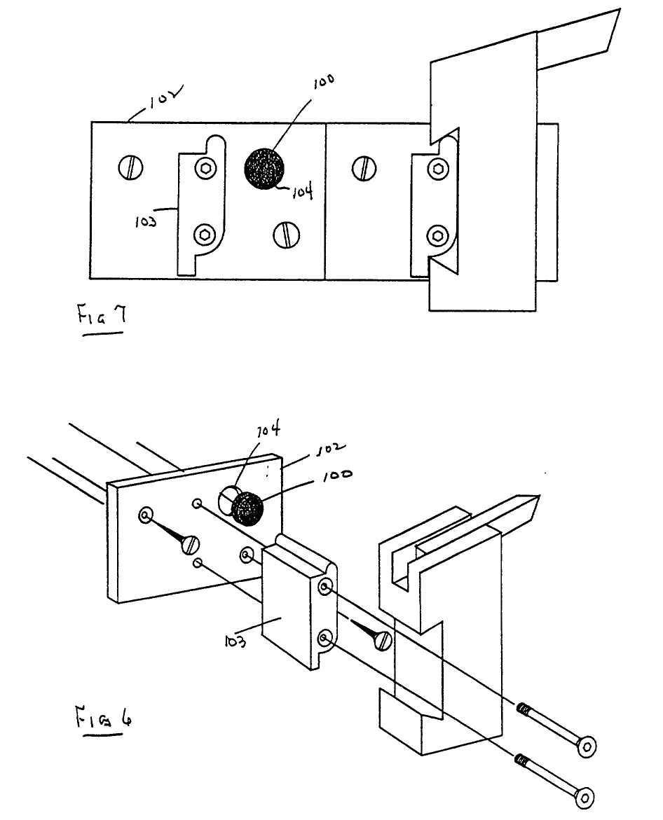

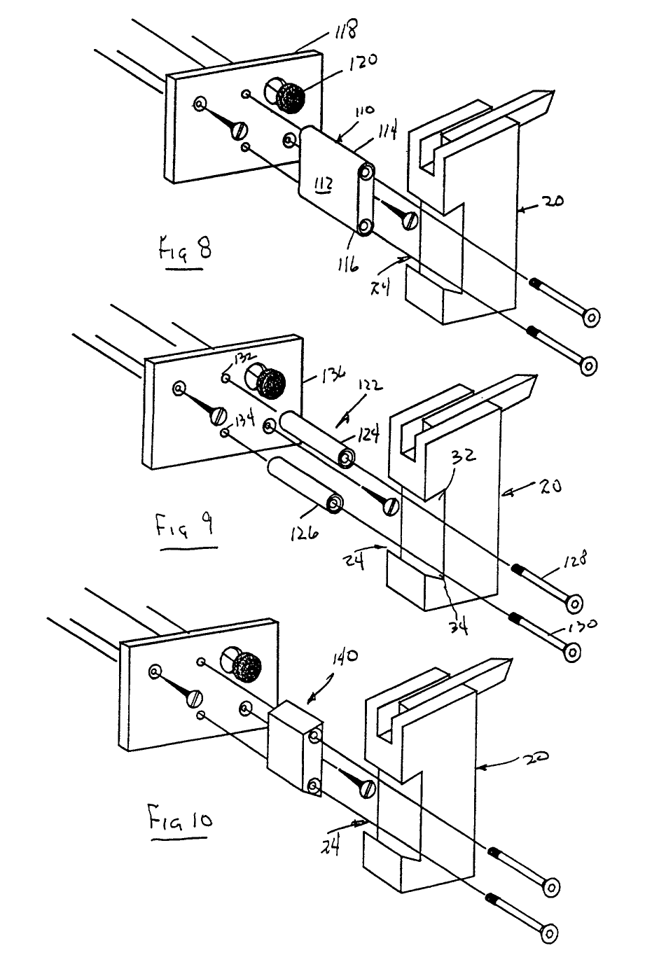

Attention is now directed to FIGS. 3-5 which depict a second rack embodiment in accordance with the present invention. The rack 80 of FIGS. 3-5 differs from the rack 40 of FIGS. 1 and 2 primarily by the inclusion of a spring detent to frictionally engage a stored tool holder 20. More particularly, hanger member 82 defines a bore 83 which extends into the lower surface 84 of the hanger member. The bore 83 accommodates a coil spring 86 which acts to urge a pin 88 outwardly beyond surface 84 and against side line surface 30 of a stored tool holder 20 (FIG. 4) to dampen tool holder vibration, prevent translational movement, and reduce noise.

FIG. 4 illustrates a modular rack assembly 90 comprised of multiple rack modules 80A, 80B, 80C, 80D. FIG. 4 demonstrates from left to right how a tool holder 20 is lowered into engagement with the projecting portion 90 of the hanger member and then rotated clockwise into a substantially vertical orientation. Note that as the tool holder rotates clockwise, it will engage pin 88, as seen in FIG. 4 with respect to rack 80C, to push the pin into bore 83 enabling the tool holder to rotate past the pin to the vertical orientation depicted with respect to module 80D. Note with respect to rack 80D, the pin 88 has emerged from the bore 83 and bears against the tool holder side line surface 30. Because of the slope of surface 30, the face 94 of the tool holder will engage with and be held against hanger member vertical surface 96. This engagement of the pin 88 against surface 30 serves to dampen vibration of the tool holder, reduce the noise chatter, and prevent translation of the tool holder along the hanger member.

Attention is now directed to FIGS. 6 and 7 which illustrate a third embodiment in which a magnet 100 is supported in mounting plate 102. The magnet 100 functions to retain the tool holder 20 suspended on hanger member 103 against the mounting plate 102 to inhibit translational movement.

More particularly, the embodiment of FIG. 7 is identical to FIG. 1 except that permanent magnet 100 is supported in mounting plate aperture 104. In use, as the tool holder is rotated about the hanger member, 103, in the same manner as shown in FIG. 1, the field produced by magnet 100 will act on the tool holder to retain it against mounting plate 102. Thus, magnet 100 inhibits the tool holder from translating along the hanger member. As a consequence, there is no need in FIGS. 6, 7 for the front retention plate shown in FIG. 1.

The embodiments of FIGS. 1-7 all contemplate that the tool holder be rotated around the hanger member in order to suspend it from the hanger member. This rotational motion is necessary in the first and second embodiments (FIGS. 1-5) because the inclusion of the front retention plate (e.g., 64) prevents sliding the tool holder onto the hanger member. However, the third embodiment of FIGS. 6, 7 eliminates the need for the retention plate by instead using a magnet to retain the tool holder to inhibit it from vibrating off of the hanger member. By eliminating the retention plate and permitting the tool holder to be placed on the hanger member by sliding, the profile requirements for the hanger member can be relaxed.

Thus, FIG. 8 illustrates a rack embodiment similar to that shown in FIGS. 6, 7 but utilizing a simpler hanger member 110 comprising a thin rectangular metal block 112 whose horizontally oriented side edges have been radiused as shown at 114, 116. The block 112 is dimensioned so that the tool holder keyway 24 can easily slide onto the block 112 enabling it to be retained against mounting plate 118 by magnet 120.

The embodiment of FIG. 9 is similar to FIG. 8 but instead of the thin block 112, the hanger member 122 comprises a pair of spaced rods 124, 126 which correspond to the aforementioned radiused edges 114, 116. The rods are apertured to accommodate through bolts 128, 130 which thread into apertures 132, 134 in mounting plate 136. The rods 124, 126 are spaced and dimensioned to be respectively received into the included angular areas 32, 34 of the tool holder for supporting the tool holder 20.

FIG. 10 shows a still further embodiment which is also similar to FIG. 6 but in which the hanger member 140 has a trapezoidal cross-sectional profile conforming to that of the tool holder keyway 24 and dimensioned so that the tool holder can snugly slide thereon.

From the foregoing, it should now be understood that a useful rack assembly has been described including at least one horizontally oriented hanger member configured to fit through the keyway of a tool holder for supporting the tool holder so that it can be readily accessed by a machine operator. Embodiments of the invention are characterized by the inclusion of a retention means for preventing, or inhibiting, translational movement of the tool holder along the hanger member. Although several rack embodiments have been described, it should be understood that various alternatives and modifications will occur to those skilled in the art which fall within the spirit of the invention and intended scope of the appended claims.

1. A rack suitable for removably retaining at least one tool holder having a mounting keyway defining a certain peripheral profile, said rack comprising:
at least one hanger member having first and second end faces, said hanger member defining a cross-sectional profile shaped and dimensioned to fit within said tool holder keyway;
means supporting said hanger member substantially horizontally so as to enable said tool holder keyway to be fitted around said hanger member for suspending said tool holder therefrom; and
retention means for inhibiting translational movement of said tool holder along said hanger member from said first end and face toward said second end face.

2. The rack of claim 1 further including a mounting plate adapted to be secured to a vertical surface; and wherein
said hanger member is detachably fastened to said mounting plate.

3. The rack of claim 1 wherein said tool holder keyway profile includes an acute angle; and wherein
said hanger member profile includes a portion dimensioned to nest in said tool holder acute angle for suspending said tool holder therefrom.

4. The rack of claim 3 wherein said hanger member portion includes a horizontally oriented radiused surface for engaging said tool holder in said acute angle; and wherein
said tool holder can rotate around said radiused surface.

5. The rack of claim 1 wherein said retention means comprises a flange formed proximate to said hanger member second end face.

6. The rack of claim 1 wherein said retention means comprises a permanent magnet acting on said tool holder to inhibit translational movement along said hanger member.

7. The rack of claim 1 wherein said retention means comprises a resilient detent for engaging said tool holder.

8. A rack assembly for storing multiple tool holders each comprising a metal block including a mounting keyway having a polygonal profile, said rack assembly including:
a mounting plate adapted to be secured to a vertically oriented surface;
a hanger member extending substantially perpendicularly from said mounting plate, said hanger member including a first end mounted proximate to said mounting plate and a second end extending in a forward direction away from said mounting plate;
said hanger member defining a cross-sectional profile dimensioned to be accommodated within said keyway profile wherein said tool holder keyway can be place around said hanger member to suspend said tool holder from said hanger member; and
retention means for inhibiting translational movement of said tool holder along said hanger member.

9. The rack assembly of claim 8 wherein said retention means includes a flange formed proximate to said hanger member second end for interfering with translational movement of said tool holder.

10. The rack assembly of claim 8 wherein said retention means includes a magnet for producing a force acting on said tool holder to inhibit translational movement.

11. The rack assembly of claim 8 wherein said retention means includes a resilient detent for bearing against said tool holder to inhibit translational movement.

12. The rack assembly of claim 8 wherein said tool holder mounting keyway profile includes an acute angle; and wherein
said hanger member defines a projection for nesting in said tool holder acute angle for supporting said tool holder.

13. The rack assembly of claim 12 wherein said hanger member projection includes a radiused support surface for enabling said tool hanger to rotate with respect to said hanger member.
